(19) United States
(12) Patent Application Publication
(10) Pub. No.: US 2025/0294305 A1
(43) Pub. Date: Sep. 18, 2025

(54) MOBILE BODY NOTIFICATION APPARATUS AND MOBILE BODY NOTIFICATION METHOD

(71) Applicant: HONDA MOTOR CO., LTD., Tokyo (JP)

(72) Inventors: Masaki Maruyama, Wako-shi (JP); Sadaharu Ishida, Tokyo (JP); Yoshiyuki Uwamino, Tokyo (JP); Masahiko Shimada, Tokyo (JP)

(21) Appl. No.: 19/012,437

(22) Filed: Jan. 7, 2025

(30) Foreign Application Priority Data
Mar. 13, 2024 (JP) 2024-038916

(51) Int. Cl. H04S 7/00; B60W 50/00; B60W 50/14; G06F 3/16

(52) U.S. Cl. CPC H04S 7/302; B60W 50/14; G06F 3/165; B60W 2050/0083; B60W 2050/143; H04R 2499/13

(57) ABSTRACT

A mobile body notification apparatus provides a notification to a driver of a mobile body. The mobile body notification apparatus includes: an approaching target object recognition section configured to recognize a target object that is approaching the mobile body; and a notification sound control section configured to, when the approaching target object recognition section recognizes the target object, output a first notification sound from a first speaker located forward of a driver seat of the mobile body and output a second notification sound from a second speaker located rearward of a seated position of the driver in the driver seat.

### INCORPORATION BY REFERENCE

The present application claims priority under 35 U.S.C. § 119 to Japanese Patent Application No. 2024-038916 filed on Mar. 13, 2024. The content of the application is incorporated herein by reference in its entirety.

### BACKGROUND OF THE INVENTION

### Field of the Invention

The present invention relates to a mobile body notification apparatus and a mobile body notification method.

### Description of the Related Art

In recent years, efforts have been increasing to provide access to sustainable transportation systems for traffic participants, especially those in vulnerable positions. To this end, focus is placed on research and development to further improve traffic safety and convenience through the research and development concerning preventive safety technology. For example, Japanese Patent Laid-Open No. 2005-8020 discloses a notification apparatus that informs a driver of a vehicle about the direction in which a danger is approaching the vehicle. Multiple speakers are placed at different positions in the interior of the vehicle, and a warning sound is output from a speaker located at a position corresponding to the direction of the danger approaching the vehicle.

In preventive safety technology, it is desired to make a driver aware of an approaching danger reliably. In systems such as the conventional notification apparatus described above, however, a speaker corresponding to the approaching direction of a danger is selected and a warning sound is output from the selected speaker. This presents a drawback of not providing the notification through a warning sound in the event of failure of the speaker corresponding to the approaching direction of the danger. Additionally, the driver may have difficulty in recognizing a warning sound if the warning sound is output from only the speaker corresponding to the approaching direction of the danger. A challenge to be solved by the present application is to make a driver in a mobile body, such as a vehicle, aware of an approaching danger further reliably.

To solve the challenge described above, the present application has an object of making a driver of a mobile body aware of an imminent danger further reliably. Consequently, the object of the present application is to contribute to the advance of sustainable transportation systems.

### SUMMARY OF THE INVENTION

A first aspect to achieve the object described above may be a mobile body notification apparatus that provides a notification to a driver of a mobile body, the apparatus including: an approaching target object recognition section configured to recognize a target object that is approaching the mobile body; and a notification sound control section configured to, when the target object is recognized by the approaching target object recognition section, output a first notification sound from a first speaker located forward of a driver seat of the mobile body and output a second notification sound from a second speaker located rearward of a seated position of the driver in the driver seat.

In the mobile body notification apparatus described above, the approaching target object recognition section may recognize an approaching direction of the target object toward the mobile body, and the notification sound control section may output the second notification sound from a second speaker among a plurality of second speakers, the plurality of second speakers being located on a right-hand side and a left-hand side of the driver seat, the second speaker being located on one side of the right-hand side and the left-hand side, the one side including the approaching direction of the target object toward the mobile body.

In the mobile body notification apparatus described above, when the approaching direction of the target object toward the mobile body recognized by the approaching target object recognition section is from front of the mobile body, the notification sound control section may inhibit output of the second notification sound from the second speaker and output only the first notification sound from the first speaker.

In the mobile body notification apparatus described above, the notification sound control section may output the first notification sound from the first speaker located in a position forward of the driver seat and opposite the driver seat.

In the mobile body notification apparatus described above, the approaching target object recognition section may recognize degree of approaching of the target object toward the mobile body, and the notification sound control section may change a frequency component of the second notification sound in accordance with the degree of approaching of the target object toward the mobile body.

In the mobile body notification apparatus described above, a driving operation recognition section configured to recognize a driving operation situation of the mobile body may be further included, and, after the notification sound control section starts outputting the first notification sound from the first speaker and the second notification sound from the second speaker, and when the driving operation recognition section recognizes that an operation for avoiding a risk posed by the target object is performed, the notification sound control section may stop outputting the first notification sound from the first speaker and the second notification sound from the second speaker.

In the mobile body notification apparatus described above, the notification sound control section may output the first notification sound and the second notification sound on a basis of a setting in which the second notification sound includes a first frequency component that is not included in the first notification sound.

In the mobile body notification apparatus described above, the notification sound control section may output the first notification sound and the second notification sound on the basis of a setting in which the first notification sound includes a second frequency component and the second notification sound includes the first frequency component and the second frequency component.

In the mobile body notification apparatus described above, a communication section configured to communicate with a mobile device may be further included, and, when the approaching target object recognition section recognizes the target object and the notification sound control section recognizes that the driver has the mobile device on the driver, the notification sound control section may transmit a signal of the second notification sound from the communication section to the mobile device to output the second notification sound from a speaker included in the mobile device.

A second aspect to achieve the object described above may be a mobile body notification apparatus that provides a notification to a driver of a mobile body, the apparatus including: an approaching target object recognition section configured to recognize a target object that is approaching the mobile body; a communication section configured to communicate with a mobile device; and a notification sound control section configured to, when the approaching target object recognition section recognizes the target object and the notification sound control section recognizes that a driver seated in a driver seat of the mobile body has the mobile device on the driver, output a first notification sound from a speaker located forward of the driver seat and transmit a signal of a second notification sound from the communication section to the mobile device to output the second notification sound from a speaker included in the mobile device.

A third aspect to achieve the object described above may be a mobile body notification method to be executed by a computer to provide a notification to a driver of a mobile body, the method including: an approaching target object recognition step of recognizing a target object that is approaching the mobile body, and a notification sound control step of, when the target object is recognized in the approaching target object recognition step, outputting a first notification sound from a first speaker located forward of a driver seat of the mobile body and outputting a second notification sound from a second speaker located rearward of a seated position of the driver in the driver seat.

The mobile body notification apparatus and the mobile body notification method described above can make a driver of a mobile body aware of an imminent danger further reliably.

### BRIEF DESCRIPTION OF THE DRAWINGS

FIG. 1 is a diagram for describing a vehicle in which a mobile body notification apparatus is installed;

FIG. 2 is a configuration diagram of the mobile body notification apparatus;

FIG. 3 is a first flowchart for processing of notification to a driver; and

FIG. 4 is a second flowchart for processing of notification to the driver.

### DETAILED DESCRIPTION OF THE INVENTION

### 1. Configuration of Vehicle

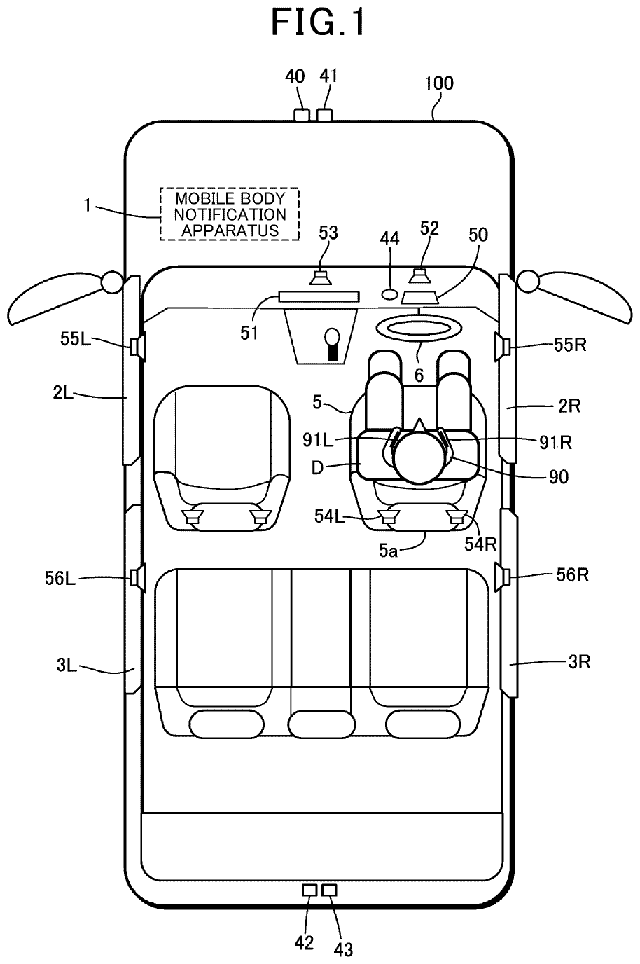

With reference to FIG. 1, a configuration of a vehicle 100 in which a mobile body notification apparatus 1 according to the present disclosure is installed is described. The mobile body notification apparatus 1 is installed in the vehicle 100 and provides a notification through a communication sound to a driver D seated in a driver seat 5. The vehicle 100 corresponds to a mobile body of the present disclosure.

The vehicle 100 includes: a front camera 40 for capturing an image forward of the vehicle 100; a front radar 41 for detecting a position of a target object existing forward of the vehicle 100; a rear camera 42 for capturing an image rearward of the vehicle 100; and a rear radar 43 for detecting a position of a target object existing rearward of the vehicle 100. A meter 50 for displaying a speed, a traveling distance, and the like, and a meter speaker 52 are located forward of the driver seat 5 and opposite the driver seat 5. Note that LiDAR may be used as a means for detecting the position of a target object.

A center speaker 53 and a display 51, such as a DA (Display Audio), are located at a center portion of a dashboard. A headrest left speaker 54L and a headrest right speaker 54R are located at a headrest 5a of the driver seat 5. The headrest left speaker 54L and the headrest right speaker 54R are located rearward of a seated position of the driver D in the driver seat 5 (i.e., the headrest left speaker 54L and the headrest right speaker 54R are located rearward of the position of the seat). A front left door speaker 55L is located at a front left door 2L, and a front right door speaker 55R is located at a front right door 2R. A rear left door speaker 56L is located at a rear left door 3L, and a rear right door speaker 56R is located at a rear right door 3R.

The mobile body notification apparatus 1 has a function of performing wireless communication with a mobile device. FIG. 1 shows a neck speaker 90 the driver D has on the driver D as an example of the mobile device. The neck speaker 90 receives a sound signal transmitted by the mobile body notification apparatus 1 and provides an output from a left speaker 91L and a right speaker 91R. The mobile body notification apparatus 1 and the neck speaker 90 perform wireless communication based on a standard, such as Bluetooth®. The mobile device may be a bone conduction earphone or the like.

### 2. Configuration of Mobile Body Notification Apparatus

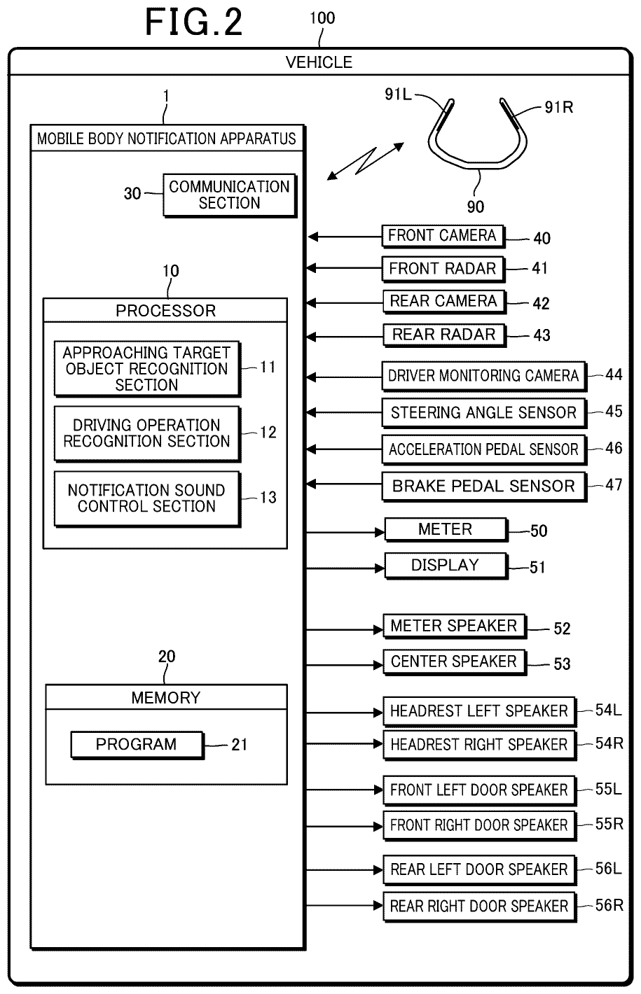

With reference to FIG. 2, a configuration of the mobile body notification apparatus 1 is described. The mobile body notification apparatus 1 is a control unit that includes a processor 10, a memory 20, a communication section 30, and the like. The mobile body notification apparatus 1 is connected to the front camera 40, the rear camera 42, and a driver monitoring camera 44, and an image captured by each of the cameras is input to the mobile body notification apparatus 1. The mobile body notification apparatus 1 is connected to the front radar 41 and the rear radar 43, and a position detection signal from each of the radars is input to the mobile body notification apparatus 1.

The mobile body notification apparatus 1 is connected to a steering angle sensor 45, an acceleration pedal sensor 46, and a brake pedal sensor 47. A detection signal indicative of a steering angle of a steering wheel 6 from the steering angle sensor 45, a detection signal indicative of an operation amount of an acceleration pedal (not shown) from the acceleration pedal sensor 46, and a detection signal indicative of an operation amount of a brake pedal (not shown) from the brake pedal sensor 47 are input to the mobile body notification apparatus 1.

The mobile body notification apparatus 1 is connected to the meter 50 and the display 51. Content displayed on screens of the meter 50 and the display 51 are controlled by image signals output by the mobile body notification apparatus 1. The mobile body notification apparatus 1 is connected to the meter speaker 52, the center speaker 53, the headrest left speaker 54L, the headrest right speaker 54R, the front left door speaker 55L, the front right door speaker 55R, the rear left door speaker 56L, and the rear right door speaker 56R. A sound signal output from the mobile body notification apparatus 1 is amplified and output by these speakers. Furthermore, the mobile body notification apparatus 1 performs wireless communication between the mobile body notification apparatus 1 and the neck speaker 90 via the communication section 30 having a transmitter and a receiver to transmit a sound signal to the neck speaker 90 and thereby output sound from the left speaker 91L and the right speaker 91R of the neck speaker 90.

A program 21 for control of the mobile body notification apparatus 1 is stored in the memory 20. The processor 10 reads and executes the program 21 and thereby functions as an approaching target object recognition section 11, a driving operation recognition section 12, and a notification sound control section 13. The approaching target object recognition section 11 recognizes a target object (another vehicle or the like) that is approaching the vehicle 100 on the basis of an image captured by the front camera 40, a position detection signal from the front radar 41, an image captured by the rear camera 42, and a position detection signal from the rear radar 43. The approaching target object recognition section 11 calculates a predicted time TTC (time to collision) until the target object reaches the vehicle 100 as degree of approaching of the target object toward the vehicle 100. The approaching target object recognition section 11 also recognizes an approaching direction of the target object toward the vehicle 100.

The driving operation recognition section 12 recognizes a situation of operation by the driver D on the steering wheel 6, the acceleration pedal, and the brake pedal on the basis of detection signals from the steering angle sensor 45, the acceleration pedal sensor 46, and the brake pedal sensor 47. The driving operation recognition section 12 may be configured to recognize a situation of operation by the driver D on the steering wheel 6 and the like from an image of the driver D captured by the driver monitoring camera 44.

When the approaching target object recognition section 11 recognizes a target object that is approaching the vehicle 100, the notification sound control section 13 outputs a first notification sound from the meter speaker 52. Additionally, the notification sound control section 13 outputs a second notification sound from the headrest left speaker 54L when the target object is approaching the vehicle 100 from a left-hand side of the vehicle 100, and the notification sound control section 13 outputs the second notification sound from the headrest right speaker 54R when the target object is approaching the vehicle 100 from a right-hand side of the vehicle 100. Here, the first notification sound and the second notification sound have frequency components described below.

The first notification sound: a dull sound (a sound having one particular frequency component (for example, 500 Hz to 1.4 kHz)).

The second notification sound: a sound having a dull sound+directional sound components (a plurality of low frequency components (for example, 300 Hz to 1 kHz) that evokes a sense of direction). The directional sound components may be a sound having a plurality of frequencies each of which is a frequency lower than that of the dull sound.

By including a directional sound component in the second notification sound as described above, the driver D can be made aware of the approaching direction of the target object toward the vehicle 100. Furthermore, by including in the first notification sound and the second notification sound, a dull sound frequency component common to both of the notification sounds, the driver D can be given a sense of coherence about the first notification sound and the second notification sound. In this way, the driver D can be made aware that a danger posed by one target object is imminent, without making the driver D feel that dangers posed by different target objects are imminent in the front of the vehicle 100 and on the left-hand side of the vehicle 100 or on the right-hand side of the vehicle 100. Furthermore, in the event of failure of the headrest left speaker 54L or the headrest right speaker 54R, the meter speaker 52 still outputs the first notification sound, ensuring that a notification is reliably provided to the driver D.

Furthermore, the notification sound control section 13 increases frequencies of the first notification sound and the second notification sound as the TTC with the target object recognized by the approaching target object recognition section 11 decreases. The notification sound control section 13 decreases frequencies of the first notification sound and the second notification sound as the TTC with the target object increases. In this way, the driver D can be made aware that the target object is approaching the vehicle 100 or that the target object is moving away from the vehicle 100.

### 3. Processing of Notification to Driver

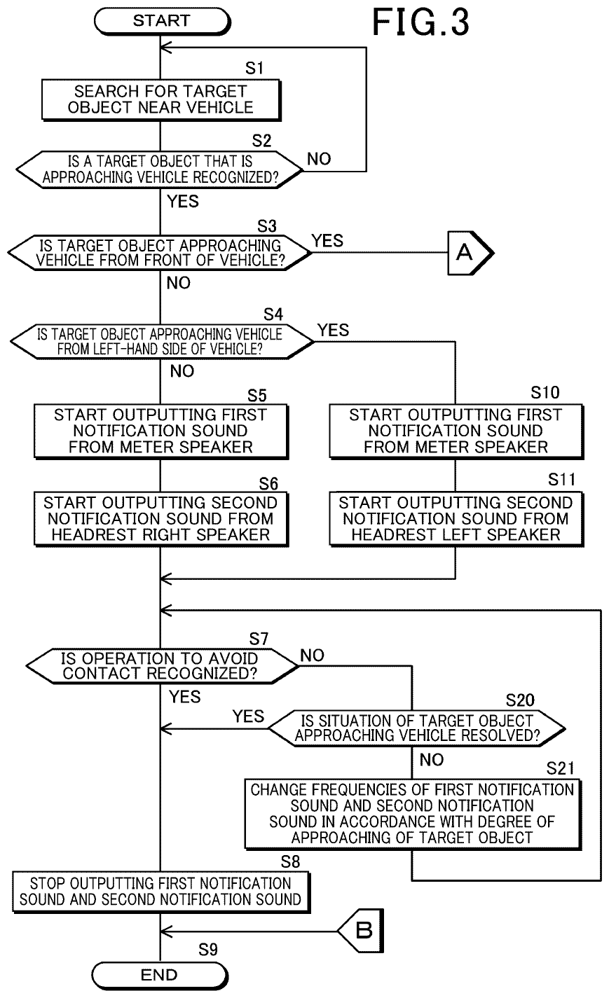

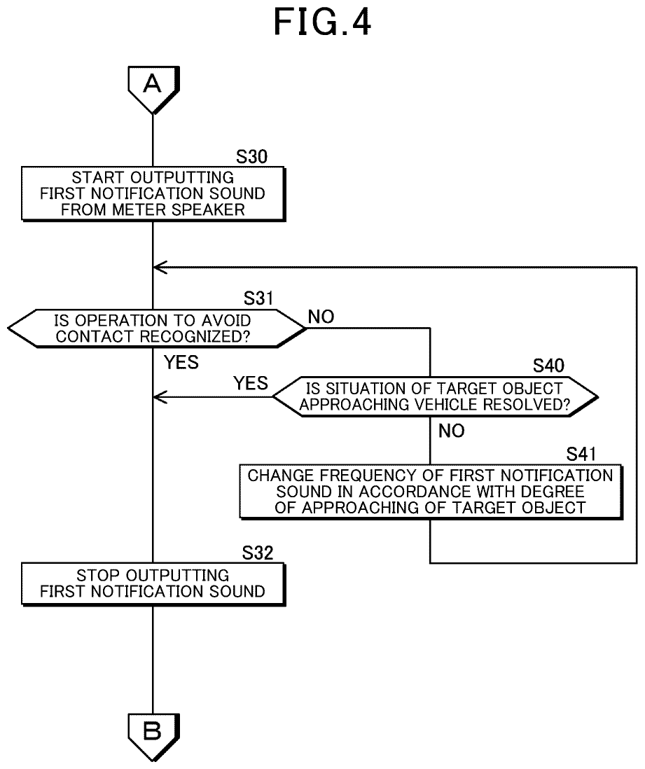

With reference to flowcharts shown in FIGS. 3 and 4, a procedure for processing of notification to the driver D performed by the mobile body notification apparatus 1 is described.

In loop processing of step S1 and step S2 in FIG. 3, the approaching target object recognition section 11 searches for a target object existing near the vehicle 100 in step S1 and, if the approaching target object recognition section 11 recognizes a target object that is approaching the vehicle 100, the approaching target object recognition section 11 proceeds to processing in step S3. If, in step S3, the approaching target object recognition section 11 recognizes that a target object is approaching the vehicle 100 from the front of the vehicle 100, the notification sound control section 13 proceeds to processing in step S30 in FIG. 4. If, in step S3, the approaching target object recognition section 11 recognizes that a target object is approaching the vehicle 100 from a direction other than from the front of the vehicle 100, the notification sound control section 13 proceeds to processing in step S4.

If, in step S4, the approaching target object recognition section 11 recognizes that the target object is approaching the vehicle 100 from the left-hand side of the vehicle 100, the notification sound control section 13 proceeds to processing in step S10. If, in step S4, the approaching target object recognition section 11 recognizes that the target object is approaching the vehicle 100 from the right-hand side of the vehicle 100, the notification sound control section 13 proceeds to processing in step S5.

In step S10, the notification sound control section 13 starts outputting the first notification sound from the meter speaker 52. In subsequent step S11, the notification sound control section 13 starts outputting the second notification sound from the headrest left speaker 54L and proceeds to processing in step S7. By the processing in steps S10 and S11, the driver D is notified that a target object is approaching the vehicle 100 from the left-hand side of the vehicle 100.

In step S5, the notification sound control section 13 starts outputting the first notification sound from the meter speaker 52. In subsequent step S6, the notification sound control section 13 starts outputting the second notification sound from the headrest right speaker 54R. By the processing in steps S5 and S6, the driver D is notified that a target object is approaching the vehicle 100 from the right-hand side of the vehicle 100.

In step S7, the notification sound control section 13 determines whether the driving operation recognition section 12 has recognized the driver D performing an operation to avoid contact with the target object. If the operation to avoid contact has been recognized, the notification sound control section 13 proceeds to processing in step S8. If the operation to avoid contact has not been recognized, the notification sound control section 13 proceeds to processing in step S20. The operation to avoid contact includes an operation on the steering wheel in a direction to move away from the target object, an operation for deceleration by decreasing the operation amount of the acceleration pedal, an operation for deceleration by increasing the operation amount of the brake pedal, and the like.

In step S8, the notification sound control section 13 stops outputting the first notification sound and the second notification sound. In this way, the driver D can be prevented from feeling annoyed by continued output of the first notification sound and the second notification sound after the driver D has performed the operation to avoid contact with the target object. In step S20, the notification sound control section 13 determines whether the approaching target object recognition section 11 has recognized the situation of the target object approaching the vehicle 100 being resolved by a change in the traveling direction of the target object, or the like.

If the situation of the target object approaching the vehicle 100 has been resolved, the notification sound control section 13 proceeds to processing in step S8. If the situation of the target object approaching the vehicle 100 continues to exist, the notification sound control section 13 proceeds to processing in step S21. In step S21, the notification sound control section 13 changes the frequencies of the first notification sound and the second notification sound in accordance with the degree of approaching of the target object recognized by the approaching target object recognition section 11 as described above, and proceeds to processing in step S7. Because of the changes in frequency of the first notification sound and the second notification sound, the driver D can intuitively recognize the situation of the target object approaching the vehicle 100 or the situation of the target object moving away from the vehicle 100.

In step S30 in FIG. 4, the notification sound control section 13 inhibits output of the second notification sound from the headrest left speaker 54L and the headrest right speaker 54R and starts outputting only the first notification sound from the meter speaker 52. By the processing of step S30, the driver D is notified that the target object is approaching the vehicle 100 from the front of the vehicle 100. In subsequent step S31, the notification sound control section 13 determines whether the driving operation recognition section 12 has recognized the driver D performing an operation to avoid contact with the target object. If the operation to avoid contact has been recognized, the notification sound control section 13 proceeds to processing in step S32. If the operation to avoid contact has not been recognized, the notification sound control section 13 proceeds to processing in step S40.

In step S32, the notification sound control section 13 stops outputting the first notification sound and proceeds to processing in step S9 in FIG. 3. In this way, the driver D can be prevented from feeling annoyed by continued output of the first notification sound after the driver D has performed an operation to avoid contact with the target object. In step S40, the notification sound control section 13 determines whether the approaching target object recognition section 11 has recognized the situation of the target object approaching the vehicle 100 being resolved by a change in the traveling direction of the target object, or the like.

If the situation of the target object approaching the vehicle 100 has been resolved, the notification sound control section 13 proceeds to processing in step S32. If the situation of the target object approaching the vehicle 100 continues to exist, the notification sound control section 13 proceeds to processing in step S41. In step S41, the notification sound control section 13 changes the frequency of the first notification sound in accordance with the degree of approaching of the target object recognized by the approaching target object recognition section 11 as described above, and proceeds to processing in step S31. Because of the change in frequency of the first notification sound, the driver D can intuitively recognize the situation of the target object approaching the vehicle 100 or the situation of the target object moving away from the vehicle 100.

### 4. Other Embodiments

In the embodiment described above, the notification sound control section 13 outputs the second notification sound from the headrest left speaker 54L or the headrest right speaker 54R. In another embodiment where the headrest left speaker 54L and the headrest right speaker 54R are not included in the vehicle 100, the second notification sound may be output from a speaker included in a mobile device, such as the neck speaker 90 shown in FIG. 1.

In this case, the notification sound control section 13 recognizes that the driver D has the mobile device on the driver D by recognizing established communication between the communication section 30 and the mobile device or by recognizing an image portion of the mobile device in an image of the driver D captured by the driver monitoring camera 44. If the approaching target object recognition section 11 recognizes a target object approaching the vehicle 100 from the left-hand side of the vehicle 100, the notification sound control section 13 outputs the first notification sound from the meter speaker 52 and outputs the second notification sound from the left speaker 91L of the neck speaker 90. If the approaching target object recognition section 11 recognizes a target object approaching the vehicle 100 from the right-hand side of the vehicle 100, the notification sound control section 13 outputs the first notification sound from the meter speaker 52 and outputs the second notification sound from the right speaker 91R of the neck speaker 90.

Alternatively, the notification sound control section 13 may output the second notification sound from a speaker located rearward of the seated position of the driver D in the driver seat 5, such as the rear left door speaker 56L and the rear right door speaker 56R.

In the embodiment described above, the notification sound control section 13 outputs the first notification sound from the meter speaker 52. Alternatively, the notification sound control section 13 may output the first notification sound from another speaker located forward of the driver seat 5, such as the center speaker 53.

In the embodiment described above, the vehicle 100 is described as the mobile body of the present disclosure. The mobile body in the present disclosure may be, besides a vehicle, any type of mobile body subjected to a driving operation by a driver, such as a flight vehicle and an aquatic vessel.

In the embodiment described above, the headrest left speaker 54L and the headrest right speaker 54R, the neck speaker 90, and the rear left door speaker 56L and the rear right door speaker 56R are described as examples of a second speaker of the present disclosure. In another embodiment, the second speaker of the present disclosure may be attached to a ceiling (roof) of the vehicle 100.

FIG. 2 is a schematic view in which a configuration of the mobile body notification apparatus 1 is divided in accordance with the main processing to facilitate understanding of the invention of the present application. The configuration of the mobile body notification apparatus 1 may be divided in any other way. Furthermore, processing of each constituent element may be executed by one hardware unit or a plurality of hardware units. Furthermore, the processing executed by each constituent element shown in FIG. 3 may be executed by one program or a plurality of programs.

### 5. Configurations Supported by the Embodiments Described Above

The embodiment described above are specific examples of the following configurations.

(First configuration) A mobile body notification apparatus that provides a notification to a driver of a mobile body, the apparatus including: an approaching target object recognition section configured to recognize a target object that is approaching the mobile body; and a notification sound control section configured to, when the target object is recognized by the approaching target object recognition section, output a first notification sound from a first speaker located forward of a driver seat of the mobile body and output a second notification sound from a second speaker located rearward of a seated position of the driver in the driver seat.

In accordance with the mobile body notification apparatus of the first configuration, the driver of the mobile body can be made aware of an imminent danger reliably by providing a notification that combines the first notification sound output from the first speaker located forward of the driver seat and the second notification sound output from the second speaker located rearward of the seated position of the driver.

(Second configuration) The mobile body notification apparatus according to the first configuration, wherein the approaching target object recognition section recognizes an approaching direction of the target object toward the mobile body, and the notification sound control section outputs the second notification sound from a second speaker among a plurality of second speakers, the plurality of second speakers being located on a right-hand side and a left-hand side of the driver seat, the second speaker being located on one side of the right-hand side and the left-hand side, the one side including the approaching direction of the target object toward the mobile body.

In accordance with the mobile body notification apparatus of the second configuration, the driver of the mobile body can be notified of the approaching direction of the target object toward the mobile body.

(Third configuration) The mobile body notification apparatus according to the second configuration, wherein, when the approaching direction of the target object toward the mobile body recognized by the approaching target object recognition section is from front of the mobile body, the notification sound control section inhibits output of the second notification sound from the second speaker and outputs only the first notification sound from the first speaker.

In accordance with the mobile body notification apparatus of the third configuration, the driver of the mobile body can be made aware of a target object that is approaching the mobile body from the front of the mobile body by outputting the first notification sound from the first speaker located forward of the driver.

(Fourth configuration) The mobile body notification apparatus according to any one of the first configuration to the third configuration, wherein the notification sound control section outputs the first notification sound from the first speaker located in a position forward of the driver seat and opposite the driver seat.

In accordance with the mobile body notification apparatus of the fourth configuration, the effect of the notification of the target object that is approaching the mobile body can be heightened by outputting the first notification sound from the first speaker, which the driver can hear with ease because the driver of the mobile body is looking ahead and the first speaker is located ahead of the driver.

(Fifth configuration) The mobile body notification apparatus according to any one of the first configuration to the fourth configuration, wherein the approaching target object recognition section recognizes degree of approaching of the target object toward the mobile body, and the notification sound control section changes a frequency component of the second notification sound in accordance with the degree of approaching of the target object toward the mobile body.

In accordance with the mobile body notification apparatus of the fifth configuration, the driver can be made aware of the degree of approaching of the target object toward the mobile body by the difference in frequency component of the second notification sound.

(Sixth configuration) The mobile body notification apparatus according to any one of the first configuration to the fifth configuration, further including a driving operation recognition section configured to recognize a driving operation situation of the mobile body, wherein, after the notification sound control section starts outputting the first notification sound from the first speaker and the second notification sound from the second speaker, and when the driving operation recognition section recognizes that an operation for avoiding a risk posed by the target object is performed, the notification sound control section stops outputting the first notification sound from the first speaker and the second notification sound from the second speaker.

In accordance with the mobile body notification apparatus of the sixth configuration, the driver can be prevented from feeling annoyed by continued output of the first notification sound and the second notification sound by stopping outputting the first notification sound and the second notification sound when the operation of avoidance by the driver is recognized.

(Seventh configuration) The mobile body notification apparatus according to any one of the first configuration to the sixth configuration, wherein the notification sound control section outputs the first notification sound and the second notification sound on a basis of a setting in which the second notification sound includes a first frequency component that is not included in the first notification sound.

In accordance with the mobile body notification apparatus of the seventh configuration, the notification about the target object can be provided to the driver in such a way that the driver feels a sense of direction toward the direction in which the second notification sound is output, by outputting the second notification sound including the first frequency component that is not included in the first notification sound.

(Eighth configuration) The mobile body notification apparatus according to the seventh configuration, wherein the notification sound control section outputs the first notification sound and the second notification sound on the basis of a setting in which the first notification sound includes a second frequency component and the second notification sound includes the first frequency component and the second frequency component.

In accordance with the mobile body notification apparatus of the eighth configuration, the driver can be made aware that the first notification sound and the second notification sound provide a notification of the same target object by including the common second frequency component in the first notification sound and the second notification sound.

(Ninth configuration) The mobile body notification apparatus according to any one of the first configuration to the eighth configuration, further including a communication section configured to communicate with a mobile device, wherein, when the approaching target object recognition section recognizes the target object and the notification sound control section recognizes that the driver has the mobile device on the driver, the notification sound control section transmits a signal of the second notification sound from the communication section to the mobile device to output the second notification sound from a speaker included in the mobile device.

In accordance with the mobile body notification apparatus of the ninth configuration, a notification about the target object can be provided to the driver by utilizing the mobile device the driver has on the driver.

(Tenth configuration) A mobile body notification apparatus that provides a notification to a driver of a mobile body, the apparatus including: an approaching target object recognition section configured to recognize a target object that is approaching the mobile body; a communication section configured to communicate with a mobile device; and a notification sound control section configured to, when the approaching target object recognition section recognizes the target object and the notification sound control section recognizes that a driver seated in a driver seat of the mobile body has the mobile device on the driver, output a first notification sound from a speaker located forward of the driver seat and transmit a signal of a second notification sound from the communication section to the mobile device to output the second notification sound from a speaker included in the mobile device.

In accordance with the mobile body notification apparatus of the tenth configuration, the driver of the mobile body can be made aware of an imminent danger further reliably by utilizing the mobile device the driver has on the driver and providing a notification that combines the first notification sound output from the first speaker located forward of the driver seat and the second notification sound output from the second speaker included in the mobile device.

(Eleventh configuration) A mobile body notification method to be executed by a computer to provide a notification to a driver of a mobile body, the method including: an approaching target object recognition step of recognizing a target object that is approaching the mobile body, and a notification sound control step of, when the target object is recognized in the approaching target object recognition step, outputting a first notification sound from a first speaker located forward of a driver seat of the mobile body and outputting a second notification sound from a second speaker located rearward of a seated position of the driver in the driver seat.

By causing the computer to execute the mobile body notification method of the eleventh configuration, the operation and effect similar to those of the mobile body notification apparatus of the first configuration can be provided.

### REFERENCE SIGNS LIST

1 . . . mobile body notification apparatus, 5 . . . driver seat, 5a . . . headrest, 10 . . . processor, 11 . . . approaching target object recognition section, 12 . . . driving operation recognition section, 13 . . . notification sound control section, 20 . . . memory, 21 . . . program, 30 . . . communication section, 40 . . . front camera, 41 . . . front radar, 42 . . . rear camera, 43 . . . rear radar, 44 . . . driver monitoring camera, 45 . . . steering angle sensor, 46 . . . acceleration pedal sensor, 47 . . . brake pedal sensor, 50 . . . meter, 51 . . . display, 52 . . . meter speaker, 53 . . . center speaker, 54L . . . headrest left speaker, 54R . . . headrest right speaker, 55L . . . front left door speaker, 55R . . . front right door speaker, 56L . . . rear left door speaker, 56R . . . rear right door speaker, 90 . . . neck speaker, 91L . . . left speaker (of neck speaker), 91R . . . right speaker (of neck speaker), D . . . driver.

1. A mobile body notification apparatus that provides a notification to a driver of a mobile body, the apparatus comprising:
an approaching target object recognition section configured to recognize a target object that is approaching the mobile body; and
a notification sound control section configured to, when the target object is recognized by the approaching target object recognition section, output a first notification sound from a first speaker located forward of a driver seat of the mobile body and output a second notification sound from a second speaker located rearward of a seated position of the driver in the driver seat.

2. The mobile body notification apparatus according to claim 1, wherein the approaching target object recognition section recognizes an approaching direction of the target object toward the mobile body, and
the notification sound control section outputs the second notification sound from a second speaker among a plurality of second speakers, the plurality of second speakers being located on a right-hand side and a left-hand side of the driver seat, the second speaker being located on one side of the right-hand side and the left-hand side, the one side including the approaching direction of the target object toward the mobile body.

3. The mobile body notification apparatus according to claim 2, wherein, when the approaching direction of the target object toward the mobile body recognized by the approaching target object recognition section is from front of the mobile body, the notification sound control section inhibits output of the second notification sound from the second speaker and outputs only the first notification sound from the first speaker.

4. The mobile body notification apparatus according to claim 1, wherein the notification sound control section outputs the first notification sound from the first speaker located in a position forward of the driver seat and opposite the driver seat.

5. The mobile body notification apparatus according to claim 1, wherein the approaching target object recognition section recognizes degree of approaching of the target object toward the mobile body, and
the notification sound control section changes a frequency component of the second notification sound in accordance with the degree of approaching of the target object toward the mobile body.

6. The mobile body notification apparatus according to claim 1, further comprising a driving operation recognition section configured to recognize a driving operation situation of the mobile body,
wherein, after the notification sound control section starts outputting the first notification sound from the first speaker and the second notification sound from the second speaker, and when the driving operation recognition section recognizes that an operation for avoiding a risk posed by the target object is performed, the notification sound control section stops outputting the first notification sound from the first speaker and the second notification sound from the second speaker.

7. The mobile body notification apparatus according to claim 1, wherein the notification sound control section outputs the first notification sound and the second notification sound on a basis of a setting in which the second notification sound includes a first frequency component that is not included in the first notification sound.

8. The mobile body notification apparatus according to claim 7, wherein the notification sound control section outputs the first notification sound and the second notification sound on the basis of a setting in which the first notification sound includes a second frequency component and the second notification sound includes the first frequency component and the second frequency component.

9. The mobile body notification apparatus according to claim 1, further comprising a communication section configured to communicate with a mobile device,
wherein, when the approaching target object recognition section recognizes the target object and the notification sound control section recognizes that the driver has the mobile device on the driver, the notification sound control section transmits a signal of the second notification sound from the communication section to the mobile device to output the second notification sound from a speaker included in the mobile device.

10. A mobile body notification apparatus that provides a notification to a driver of a mobile body, the apparatus comprising:
an approaching target object recognition section configured to recognize a target object that is approaching the mobile body;
a communication section configured to communicate with a mobile device; and
a notification sound control section configured to, when the approaching target object recognition section recognizes the target object and the notification sound control section recognizes that a driver seated in a driver seat of the mobile body has the mobile device on the driver, output a first notification sound from a speaker located forward of the driver seat and transmit a signal of a second notification sound from the communication section to the mobile device to output the second notification sound from a speaker included in the mobile device.

11. A mobile body notification method to be executed by a computer to provide a notification to a driver of a mobile body, the method comprising:
an approaching target object recognition step of recognizing a target object that is approaching the mobile body, and
a notification sound control step of, when the target object is recognized in the approaching target object recognition step, outputting a first notification sound from a first speaker located forward of a driver seat of the mobile body and outputting a second notification sound from a second speaker located rearward of a seated position of the driver in the driver seat.
